(19) United States
(12) Patent Application Publication
(10) Pub. No.: US 2023/0281084 A1
(43) Pub. Date: Sep. 7, 2023

(54) SYSTEM AND METHOD FOR DELETING PARENT SNAPSHOTS OF RUNNING POINTS OF STORAGE OBJECTS USING EXCLUSIVE NODE LISTS OF THE PARENT SNAPSHOTS

(71) Applicant: VMware, Inc., Palo Alto, CA (US)

(72) Inventors: Enning Xiang, San Jose, CA (US); Wenguang Wang, Santa Clara, CA (US); Yiqi Xu, Mountain View, CA (US); Yifan Wang, San Jose, CA (US)

(21) Appl. No.: 17/684,177

(22) Filed: Mar. 1, 2022

(51) Int. Cl. G06F 11/14

(52) U.S. Cl. CPC G06F 11/1453; G06F 2201/84

(57) ABSTRACT

System and method for deleting parent snapshots of running points of storage objects stored in a storage system, in response to a request to delete a parent snapshot of a running point of a storage object stored in the storage system, traverses a subtree of a B tree that corresponds to a logical map of the parent snapshot to find nodes of the subtree that are exclusively owned by the parent snapshot, which are added to an exclusive node list of the parent snapshot. The minimum node ownership value of the running point is then changed to the minimum node ownership value of the parent snapshot so that any node of the subtree of the B tree with a node ownership value equal to or greater than the changed minimum node ownership value is deemed to be owned by the running point. The nodes of the subtree of the B tree that are found in the exclusive node list of the parent snapshot are then deleted.

### BACKGROUND

Snapshot technology is commonly used to preserve point-in-time (PIT) state and data of a virtual computing instance (VCI), such as a virtual machine. Snapshots of VCIs are used for various applications, such as VCI replication, VCI rollback and data protection for backup and recovery.

Current snapshot technology can be classified into two types of snapshot techniques. The first type of snapshot techniques includes redo-log based snapshot techniques, which involve maintaining changes for each snapshot in separate redo logs. A concern with this approach is that the snapshot technique cannot be scaled to manage a large number of snapshots, for example, hundreds of snapshots. In addition, this approach requires intensive computations to consolidate across different snapshots.

The second type of snapshot techniques includes tree-based snapshot techniques, which involve creating a chain or series of snapshots to maintain changes to the underlying data using a B tree structure, such as a B+ tree structure, where each snapshot has its own logical map in the B tree structure that manages the mapping between the logical block addresses to the physical block addresses. Significant advantage of the tree-based snapshot techniques over the redo-log based snapshot techniques is the scalability of the tree-based snapshot techniques. However, the snapshot B tree structures of the tree-based snapshot techniques may include many nodes that are shared by multiple snapshots. When a snapshot is requested to be deleted, the logical map of the snapshot needs to be deleted. The B tree nodes that are exclusive owned by the snapshot being deleted can be removed. However, the B tree nodes shared by multiple snapshots cannot be deleted. Consequently, the nodes of the snapshot B tree structures need to be efficiently managed, especially when the snapshots are being deleted.

### BRIEF DESCRIPTION OF THE DRAWINGS

FIG. 1 is a block diagram of a distributed storage system in which embodiments of the invention may be implemented.

FIGS. 2A-2C illustrate a copy-on-write (COW) B+ tree structure for metadata of one storage object managed by a host computer in the distributed storage system of FIG. 1 in accordance with an embodiment of the invention.

FIG. 3 illustrates a hierarchy of snapshots for a storage object in accordance with an embodiment of the invention.

FIG. 4 illustrates a snapshot manager, which may reside in each virtual storage area network (VSAN) module of host computers in the distributed storage system of FIG. 1, that manages snapshots of storage objects in accordance with an embodiment of the invention.

FIG. 5 is a flow diagram of an operation executed by a snapshot manager to delete the parent snapshot of the running point of a storage object in accordance with an embodiment of the invention.

FIG. 6 is a flow diagram of a process to execute the first stage of the parent snapshot delete operation in accordance with an embodiment of the invention.

FIG. 7 is a flow diagram of a process to execute the second stage of the parent snapshot delete operation in accordance with an embodiment of the invention.

FIG. 8 is a flow diagram of a process to execute the third stage of the parent snapshot delete operation in accordance with an embodiment of the invention.

FIG. 9 is a flow diagram of a process to execute the fourth stage of the parent snapshot delete operation in accordance with an embodiment of the invention.

FIG. 10A-10C illustrate the parent snapshot delete operation on a COW B+ tree structure in accordance with an embodiment of the invention.

FIG. 11 is a block diagram of components of the VSAN module in accordance with an embodiment of the invention.

FIG. 12 is a flow diagram of a computer-implemented method for deleting parent snapshots of running points of storage objects stored in a storage system in accordance with an embodiment of the invention.

Throughout the description, similar reference numbers may be used to identify similar elements.

### DETAILED DESCRIPTION

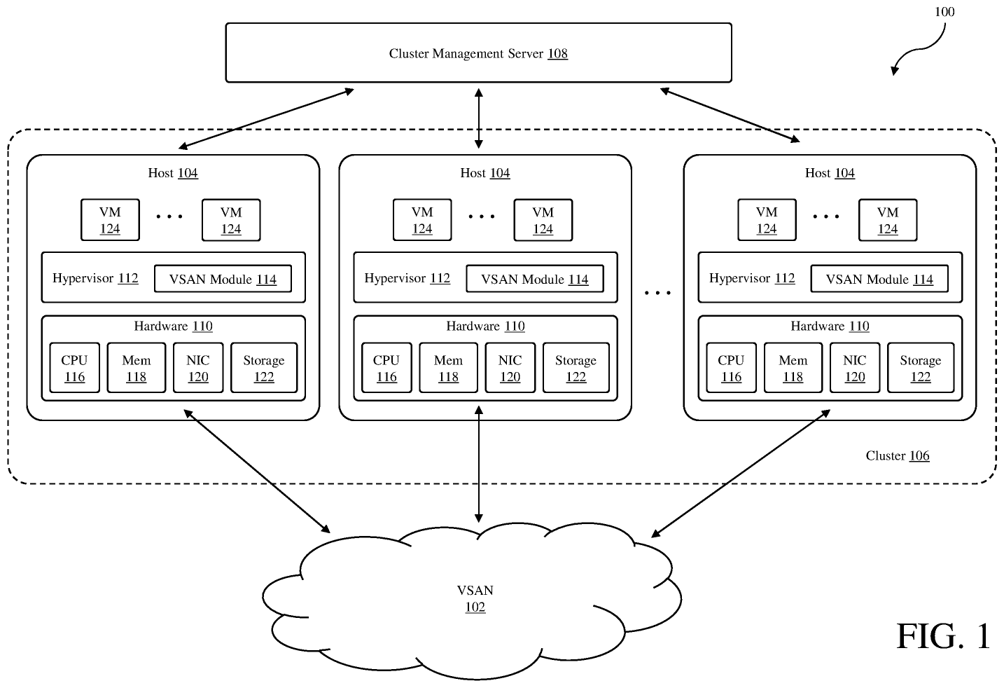

FIG. 1 illustrates a distributed storage system 100 with a storage system 102 in which embodiments of the invention may be implemented. In the illustrated embodiment, the storage system 102 is implemented in the form of a software-based “virtual storage area network” (VSAN) that leverages local storage resources of host computers 104, which are part of a logically defined cluster 106 of host computers that is managed by a cluster management server 108 in the distributed storage system 100. The VSAN 102 allows local storage resources of the host computers 104 to be aggregated to form a shared pool of storage resources, which allows the host computers 104, including any virtual computing instances (VCIs) running on the host computers, to use the shared storage resources. In particular, the VSAN 102 may be used to store and manage series of snapshots for storage objects, which may be any type of storage objects that can be stored on physical storage, such as files (e.g., virtual disk files), folders and volumes, in an efficient manner, as described herein.

As used herein, the term “virtual computing instance” refers to any software processing entity that can run on a computer system, such as a software application, a software process, a virtual machine or a virtual container. A virtual machine is an emulation of a physical computer system in the form of a software computer that, like a physical computer, can run an operating system and applications. A virtual machine may be comprised of a set of specification and configuration files and is backed by the physical resources of the physical host computer. A virtual machine may have virtual devices that provide the same functionality as physical hardware and have additional benefits in terms of portability, manageability, and security. An example of a virtual machine is the virtual machine created using VMware vSphere® solution made commercially available from VMware, Inc of Palo Alto, Calif. A virtual container is a package that relies on virtual isolation to deploy and run applications that access a shared operating system (OS) kernel. An example of a virtual container is the virtual container created using a Docker engine made available by Docker, Inc. In this disclosure, the virtual computing instances will be described as being virtual machines, although embodiments of the invention described herein are not limited to virtual machines (VMs).

The cluster management server 108 of the distributed storage system 100 operates to manage and monitor the cluster 106 of host computers 104. The cluster management server 108 may be configured to allow an administrator to create the cluster 106, add host computers to the cluster and delete host computers from the cluster. The cluster management server 108 may also be configured to allow an administrator to change settings or parameters of the host computers in the cluster regarding the VSAN 102, which is formed using the local storage resources of the host computers in the cluster. The cluster management server 108 may further be configured to monitor the current configurations of the host computers and any VCIs running on the host computers, for example, VMs. The monitored configurations may include hardware and/or software configurations of each of the host computers. The monitored configurations may also include VCI hosting information, i.e., which VCIs (e.g., VMs) are hosted or running on which host computers. The monitored configurations may also include information regarding the VCIs running on the different host computers in the cluster.

The cluster management server 108 may also perform operations to manage the VCIs and the host computers 104 in the cluster 106. As an example, the cluster management server 108 may be configured to perform various resource management operations for the cluster, including VCI placement operations for either initial placement of VCIs and/or load balancing. The process for initial placement of VCIs, such as VMs, may involve selecting suitable host computers for placement of the virtual instances based on, for example, memory and central processing unit (CPU) requirements of the VCIs, the current memory and CPU loads on all the host computers in the cluster, and the memory and CPU capacity of all the host computers in the cluster.

In some embodiments, the cluster management server 108 may be a physical computer. In other embodiments, the cluster management server may be implemented as one or more software programs running on one or more physical computers, such as the host computers 104 in the cluster 106, or running on one or more VCIs, which may be hosted on any host computers. In an implementation, the cluster management server is a VMware vCenter™ server with at least some of the features available for such a server.

As illustrated in FIG. 1, each host computer 104 in the cluster 106 includes hardware 110, a hypervisor 112, and a VSAN module 114. The hardware 110 of each host computer includes hardware components commonly found in a physical computer system, such as one or more processors 116, one or more system memories 118, one or more network interfaces 120 and one or more local computer data storage devices 122 (collectively referred to herein as “local storage”). Each processor 116 can be any type of a processor, such as a CPU commonly found in a server. In some embodiments, each processor may be a multi-core processor, and thus, includes multiple independent processing units or cores. Each system memory 118, which may be random access memory (RAM), is the volatile memory of the host computer 104. The network interface 120 is an interface that allows the host computer to communicate with a network, such as the Internet. As an example, the network interface may be a network interface card (NIC). Each local storage device 122 is a nonvolatile storage, which may be, for example, a solid-state drive (SSD) or a magnetic disk.

The hypervisor 112 of each host computer 104, which is a software interface layer, enables sharing of the hardware resources of the host computer by VMs 124, running on the host computer using virtualization technology. With the support of the hypervisor 112, the VMs provide isolated execution spaces for guest software. In other embodiments, the hypervisor may be replaced with an appropriate virtualization software to support a different type of VCIs.

The VSAN module 114 of each host computer 104 provides access to the local storage resources of that host computer (e.g., handle storage input/output (I/O) operations to data objects stored in the local storage resources as part of the VSAN 102) by other host computers 104 in the cluster 106 or any software entities, such as VMs 124, running on the host computers in the cluster. As an example, the VSAN module of each host computer allows any VM running on any of the host computers in the cluster to access data stored in the local storage resources of that host computer, which may include virtual disks (or portions thereof) of VMs running on any of the host computers and other related files of those VMs. In addition, the VSAN module generates and manages snapshots of storage objects, such as virtual disk files of the VMs, in an efficient manner, where each snapshot has its own logical map that manages the mapping between logical block addresses to physical block addresses for the data of the snapshot.

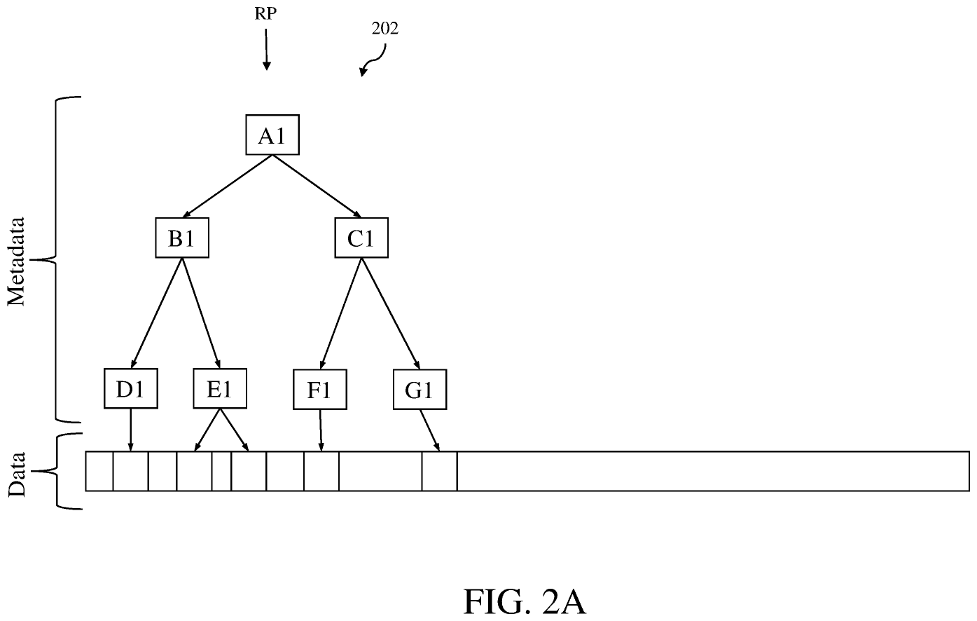

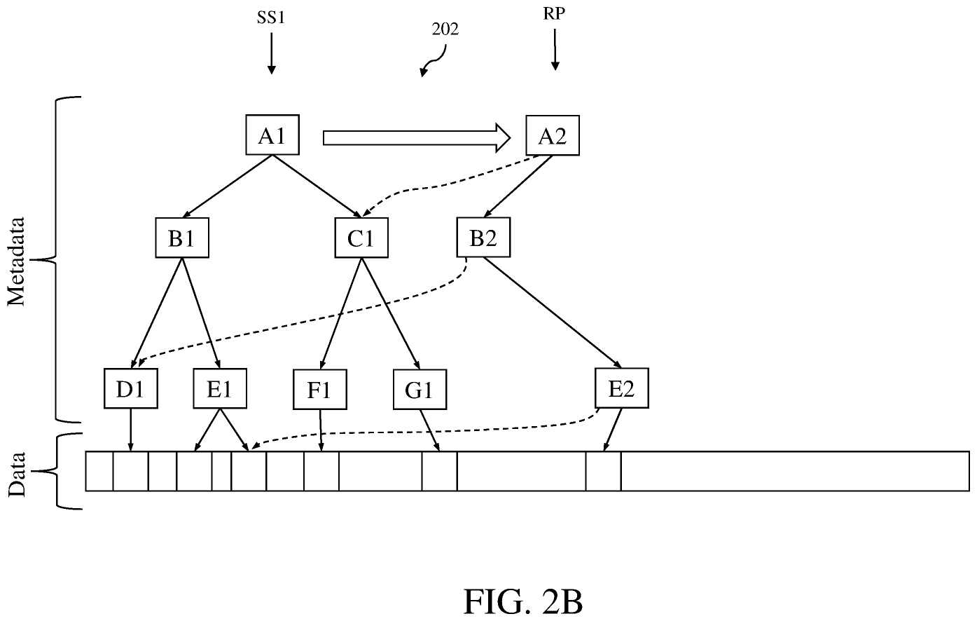

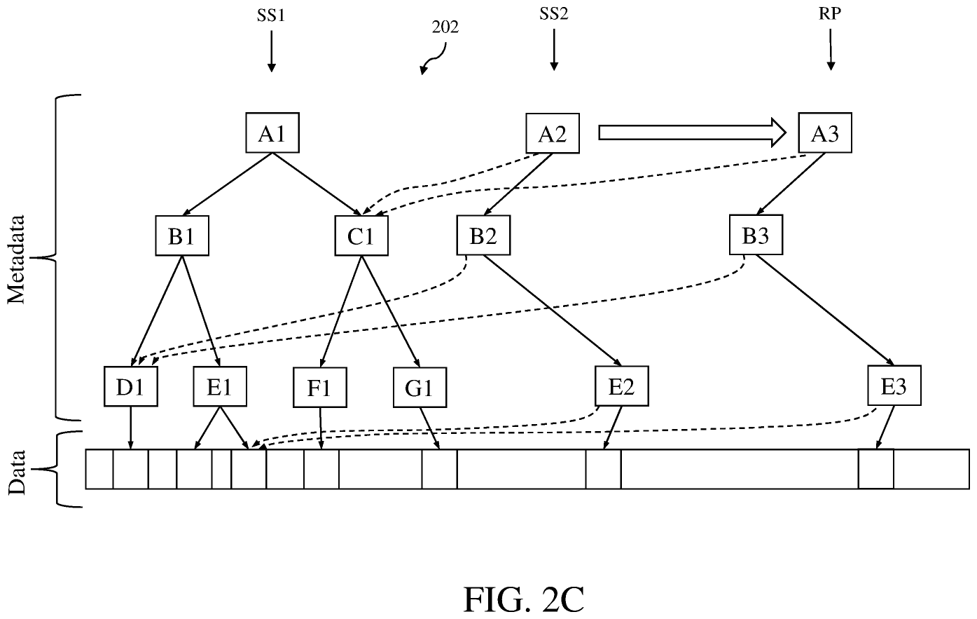

In an embodiment, the VSAN module 114 leverages B tree structures, such as copy-on-write (COW) B+ tree structures, to organize storage objects and their snapshots taken at different times. In this embodiment, a single COW B+ tree structure can be used to build up the logical maps for all the snapshots of a storage object, which saves the space overhead of B+ tree nodes with shared mapping entries, as compared to standard B+ tree structure per snapshot logical map approach. An example of a COW B+ tree structure for one storage object managed by the VSAN module 114 in accordance with an embodiment of the invention is illustrated in FIGS. 2A-2C. In this embodiment, the storage object includes data, which is the actual data of the storage object, and metadata, which is information regarding the COW B+ tree structure used to store the actual data in the VSAN 102.

FIG. 2A shows the storage object before any snapshots of the storage object were taken. The storage object comprises data, which is stored in data blocks in the VSAN 102, as defined by a COW B+ tree structure 202. Currently, the B+ tree structure 202 includes nodes A1-G1, which define one tree of the B+ tree structure (or one sub-tree if the entire B+ tree structure is viewed as being a single tree). The node A1 is the root node of the tree. The nodes B1 and C1 are index nodes of the tree. The nodes D1-G1 are leaf nodes of the tree, which are the nodes on the bottom layer of the tree. As snapshots of the storage object are created, more root, index and leaf nodes, and thus, more trees may be created. Each root node contains references that point to index nodes. Each index node contains references that point to other nodes. Each leaf node records the mapping from logical block address (LBA) to the physical location or address in the storage system. Each node in the B+ tree structure may include a node header and a number of references or entries. Each entry in the leaf nodes may include an LBA, physical extent location, checksum and other characteristics of the data for this entry. In FIG. 2A, the entire B+ tree structure 202 is the logical map of the running point, which can be viewed as the current state or running point (RP) of the storage object. Thus, all the nodes of the B+ tree structure 202 are not shared with any ancestor snapshots. As such, the nodes A1-G1 are exclusive owned by the running point and are modifiable. Consequently, the nodes A1-G1 can be updated in-place for new writes without the need to copy out the nodes.

FIG. 2B shows the storage object after a first snapshot SS1 of the storage object was taken. Once the first snapshot SS1 is created or taken, all the nodes in the B+ tree structure 202 become immutable (i.e., cannot be modified). In FIG. 2B, the nodes A1-G1 have become immutable, preserving the storage object to a point in time when the first snapshot SS1 was taken. Thus, in FIG. 2B, the subtree of the B+ tree structure 202 with the nodes A1-G1 is the logical map of the first snapshot SS1. In some embodiments, each snapshot of a storage object may include a snapshot generation identification (ID) and data regarding all the nodes in the B+ tree structure for that snapshot, e.g., the nodes A1-G1 of the B+ tree structure 202 for the first snapshot SS1 in the example shown in FIG. 2B.

When a modification of the storage object is made, after the first snapshot SS1 is created, a new root node and one or more index and leaf nodes are created. In FIG. 2B, new nodes A2, B2 and E2 have been created after the first snapshot SS1 was taken, which now partially define the running point of the storage object. Thus, the nodes A2, B2 and E2, as well as the nodes C1, D1, F1 and G1, which are common nodes for both the first snapshot SS1 and the current running point, represent the current state of the storage object. As such, in FIG. 2B, the subtree of the B+ tree structure 202 with the nodes A2, B2, C1, D1, E2, F1 and G1 is the logical map of the running point.

In FIG. 2B, the leaf node E2 of the COW B+ tree structure 202 is exclusively owned by the running point and not shared with any ancestor snapshots, i.e., the snapshot SS1. Thus, the leaf node E2 can be updated without copying out a new leaf node. However, the leaf node D1 is shared by the running point and the snapshot SS1, which is the parent snapshot of the running point. Thus, in order to revise or modify the leaf node D1, a copy of the leaf node D1 must be made as a new leaf node that is exclusively owned by the running point, which can then be revised or modified.

FIG. 2C shows the storage object after a second snapshot SS2 of the storage object was taken. As noted above, once a snapshot is created or taken, all the nodes in the B+ tree structure become immutable. Thus, in FIG. 2C, the nodes A2, B2 and E2 have become immutable, preserving the storage object to a point in time when the second snapshot SS2 was taken. Thus, the subtree with the nodes A2, B2, E2, C1, D1, F1 and G1 is the logical map of the second snapshot. When a modification of the storage object is made after the second snapshot SS2 is created, a new root node and one or more index and leaf nodes are created. In FIG. 2C, new nodes A3, B3 and E3 have been created after the second snapshot was taken. Thus, nodes A3, B3 and E3, as well as the nodes C1, D1, F1 and G1, which are common nodes for both the second snapshot and the current running point, represent the current state of the storage object. As such, in FIG. 2C, the subtree of the B+ tree structure 202 with the nodes A3, B3, C1, D1, E3, F1 and G1 is the logical map of the running point.

In FIG. 2C, the leaf node E3 of the COW B+ tree structure 202 is exclusively owned by the running point and not shared with any ancestor snapshots, i.e., the snapshots SS1 and SS2. Thus, the leaf node E3 can be updated without copying out a new leaf node. However, the leaf nodes D1, F1 and G1 are shared by the running point and the snapshots SS1 and SS2. Thus, in order to revise or modify any of these shared leaf nodes, a copy of the original leaf node must be made as a new leaf node that is exclusively owned by the running point, which can then be revised or modified.

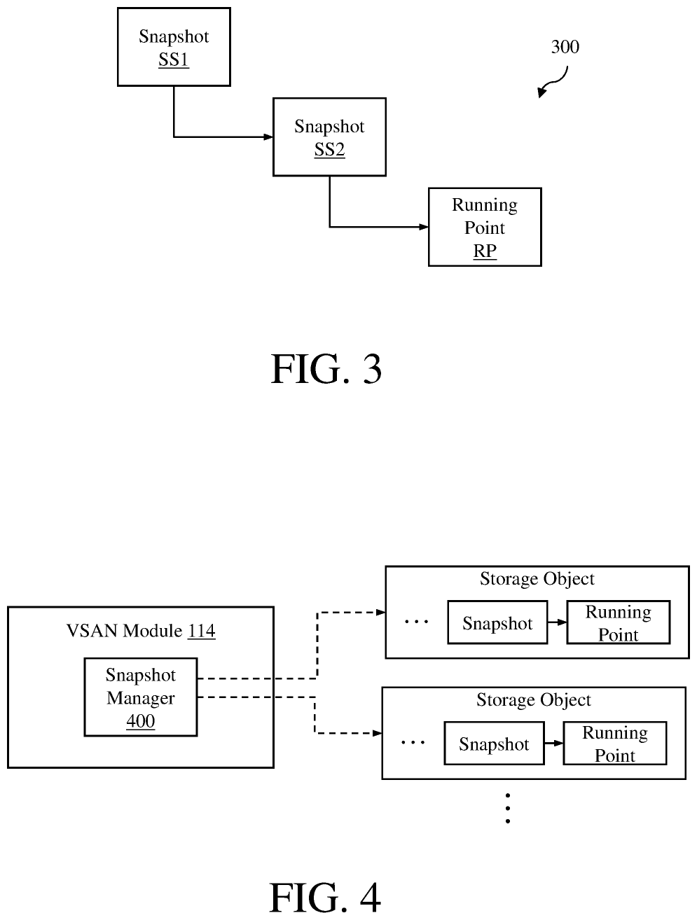

In this manner, multiple snapshots of a storage object can be created at different times. These multiple snapshots create a hierarchy of snapshots. FIG. 3 illustrates a hierarchy 300 of snapshots for the example described above with respect to FIGS. 2A-2C. As shown in FIG. 3, the hierarchy 300 includes the first snapshot SS1, the second snapshot SS2 and the running point RP. The first snapshot SS1 is the parent snapshot of the second snapshot SS2, which is the parent snapshot of the running point RP or the current state. Thus, the first snapshot SS1 is the grandparent snapshot of the running point. The snapshot hierarchy 300 illustrates how snapshots of a storage object can be visualized.

As more COW B+ tree snapshots are created for a storage object, e.g., a virtual disk of a virtual machine, more nodes are shared by the various snapshots. When a snapshot is requested to be deleted, the logical map of that snapshot needs to be deleted. However, not all COW B+ tree nodes for a snapshot can be deleted when that snapshot is being deleted. There are two catalogs or types of COW B+ tree nodes accessible to a snapshot logical map: (1) exclusively owned nodes and (2) shared nodes. Exclusively owned nodes are nodes that are exclusively owned by a snapshot, which can be deleted when the snapshot is deleted. Shared nodes are nodes that are shared by multiple snapshots, which cannot be deleted when one of the snapshot is being deleted since the nodes are needed by at least one other snapshot. When a snapshot is being deleted, shared nodes of the snapshot are unlinked from the logical map subtree of the COW B+ tree for the snapshot, but remain linked to the other snapshot(s).

In some embodiments, a performance-efficient method is used to manage the shared status of a logical map COW B+ tree node. In these embodiments, each node is stamped, when the node is created, with a monotonically increased sequence value (SV), which can be used as a node ownership value, as explained below. These monotonically increased SVs may be exclusively numbers, alphanumerical characters or other symbols/characters with increasing values. Each snapshot is also assigned with the current SV when the snapshot is created. This SV assigned to the snapshot is the minimum SV of all nodes owned by the snapshot. Thus, the SV assigned to each snapshot is referred to herein as the minimum SV or minSV, which can be used as a minimum node ownership value. A node is shared between a snapshot and its parent snapshot if the SV of the node is smaller than the minSV of the snapshot since the node was generated before the snapshot was created. A node is exclusively owned by a snapshot if the SV of the node is equal to or larger than the minSV of the snapshot. Thus, the system can quickly determine the shared status of nodes for write requests at the running point (i.e., the current state of a storage object). Unshared nodes are reused for new writes. However, shared nodes are copied out first as new nodes, which are then used for new writes. This approach is more performance efficient than some state-of-art methods, such as shared bits, to manage the shared status of logical map COW B+ tree nodes since no input/output (IO) is required to update the shared status changes for individual nodes.

However, there is one challenging problem when the parent snapshot of the running point is being deleted under the performance efficient approach. During deletion of the parent snapshot, the shared nodes are just unlinked from the COW B+ tree subtree of the logical map for the parent snapshot. When a shared node is involved in a write at the running point, the system cannot distinguish whether the shared node is already unlinked from the logical map subtree of the parent snapshot or not. Totally different actions need to be taken based on the sharing status of a node. For a shared node still accessible to the parent snapshot that is involved in a write, a new node needs to be copied out from the shared node. For a node unlinked from the parent snapshot that is involved in a write, the system needs to in-place update the node. Misjudgment on the sharing status of the node will result in orphan nodes or data loss.

In an embodiment, as illustrated in FIG. 4, each VSAN module 114 in the distributed storage system 100 includes a snapshot manager 400 that manages snapshots of storage objects that are handled or owned by that VSAN module. The snapshot manager facilitates the creation and deletion of snapshots of storage objects using B tree structures, such as the B+ tree structure 202 illustrated in FIGS. 2A-2C. Using the monotonically increased SVs assigned to the B tree nodes and the minSVs of the snapshots, the snapshot manager can easily determine the shared status of nodes for a particular snapshot of a storage object. If the SV of a node that is accessible to a snapshot is smaller than the minSV of the snapshot, then that node is shared between the snapshot and its parent snapshot since the node was generated before the snapshot was created. If the SV of a node that is accessible to a snapshot is equal to or larger than the minSV of the snapshot, then that node is exclusively owned by the snapshot.

When deleting an ordinary snapshot, i.e., snapshots other than the parent snapshots of running points of storage objects, the nodes exclusively owned by that snapshot are deleted. However, the shared nodes that are accessible by the snapshot being deleted cannot be removed (i.e., deleted). Thus, these shared nodes are unlinked from the logical map subtree of the snapshot, but not deleted so that the shared nodes are accessible to other snapshot(s). However, as noted above, during deletion of the parent snapshot of a running point, the snapshot manager cannot distinguish whether nodes that are shared by the parent snapshot and the running point have been unlinked from the logical map subtree of the parent snapshot or not. Thus, when deleting the parent snapshot of a running point, the nodes of the parent snapshot are handled differently by the snapshot manager to ensure that new write requests at the running point that involve shared nodes (i.e., nodes that are shared by the parent snapshot and the running point) are properly processed. As used herein, a node is involved in a write request if the node needs to be updated to fulfill the write request.

In the distributed storage system 100, the snapshot manager 400 of each VSAN module 114 in the respective host computer 104 is able to properly delete nodes that are shared by the running point and its parent snapshot when the parent snapshot is being deleted. As described in more detail below, the snapshot manager uses an exclusive node list that will contain nodes that are exclusively owned by the parent snapshot of the running point, which can be deleted at an appropriate time. All non-shared nodes accessible to the parent snapshot are added to the exclusive node list. The minimum node ownership value (e.g., minSV) of the running point is then updated to the minimum node ownership value of the parent snapshot in order to transfer the ownership of all remaining nodes shared between the parent snapshot and the running point. However, if there are any writes at the running point that involve the shared nodes before the ownership transfer, these shared nodes are first copied out to produce new nodes that are then used for the writes. The new nodes are exclusively owned by the running point. However, the original shared nodes are now exclusively owned by the parent snapshot. Thus, these original shared nodes that have been copied out are also added to the exclusive node list. After the ownership transfer, the nodes in the exclusive node list are deleted from the B+ tree subtree corresponding to the logical map of the parent snapshot.

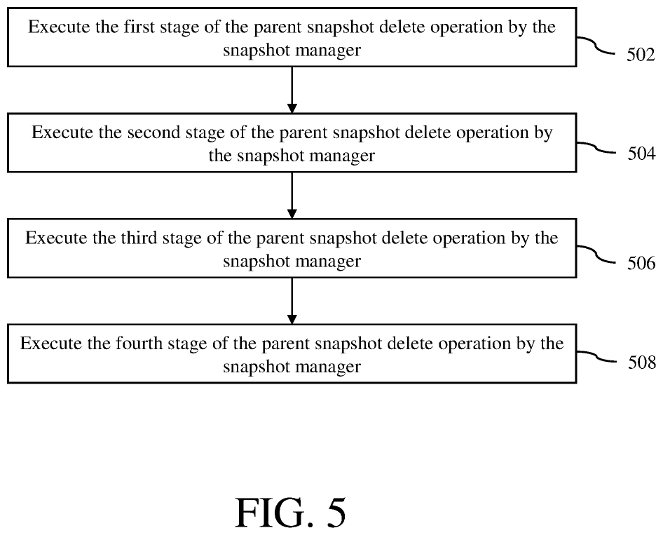

An operation executed by a particular snapshot manager 400 in the distributed storage system 100 to delete the parent snapshot of the running point of a storage object in accordance with an embodiment is described with reference to a process flow diagram of FIG. 5. The operation can be divided into four stages: first, second, third and fourth stages. The first, third and fourth stages are executed in series. However, the second stage is mostly executed in parallel with the first stage before the third stage is initiated.

At block 502, the first stage of the parent snapshot delete operation is executed by the snapshot manager 400. During this stage, the COW B+ subtree corresponding to the logical map of the parent snapshot of the storage object running point (i.e., the running point of the storage object) is traversed to determine all the nodes of the COW B+ subtree of the parent snapshot logical map that are exclusively owned by the parent snapshot. A node of the COW B+ subtree of the parent snapshot logical map that is not accessible to the running point and also not accessible to the grandparent snapshot of the running point is exclusively owned by the parent snapshot. A node of the COW B+ subtree of the parent snapshot logical map that is accessible to the running point and/or the grandparent snapshot of the running point is a shared node. All the nodes that are exclusively owned by the parent snapshot, are added to the exclusive node list.

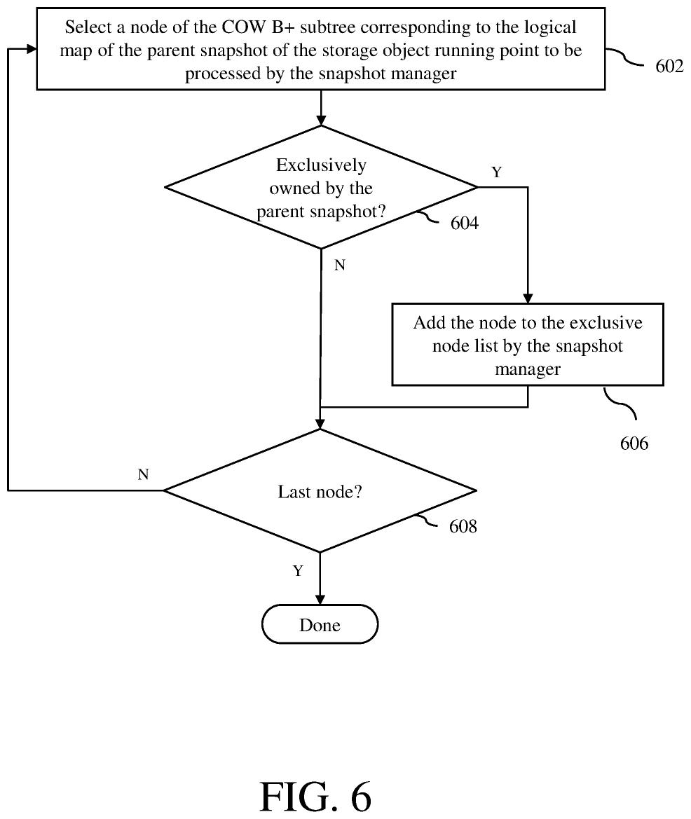

Turning now to FIG. 6, a flow diagram of a process to execute the first stage of the parent snapshot delete operation in accordance with an embodiment of the invention is shown. At step 602, a node of the COW B+ subtree corresponding to the logical map of the parent snapshot of the storage object running point is selected to be processed by the snapshot manager 400. Next, at step 604, a determination is made by the snapshot manager whether the node is exclusively owned by the parent snapshot, i.e., not accessible to the running point or the grandparent snapshot of the running point. In an embodiment, a node of the COW B+ subtree is determined to be not accessible to the grandparent snapshot of the running if the SV of the node is equal to or greater than the minSV of the parent snapshot. In an embodiment, a node of the COW B+ subtree is determined to be not accessible to the running point if a key, e.g., the minimum key, of the node is not found in the logical map of the running point. Keys of nodes of a COW B+ tree are described below.

If the node is determined to be exclusively owned by the parent snapshot, then the process proceeds to step 606, where the node is added to the exclusive node list by the snapshot manager 400. The process then proceeds to step 608. However, if the node is determined to be not exclusively owned by the parent snapshot, then the process proceeds directly to step 608.

At step 608, a determination is made by the snapshot manager 400 whether the current node is the last node of the COW B+ subtree corresponding to the logical map of the parent snapshot to be processed. If the current node is the last node to be processed, then the process is completed. However, if the current node is not the last node to be processed, the proceeds back to step 602, where the next node of the COW B+ subtree corresponding to the logical map of the parent snapshot is selected to be processed.

In an embodiment, if the current node has one or more child nodes, then one of those child nodes may be selected to be processed next. If the current node does not have any child nodes, then a sibling node of the current node may be selected to be processed next. If the current node does not have sibling nodes, then a sibling node of a processed node closest to the current node may be selected to be processed next. This process of selecting the next node to be processed is repeated until all the nodes of the COW B+ subtree corresponding to the logical map of the parent snapshot have been processed. In other embodiments, any selection process may be used to select the next node to be processed, such as a random selection process or a selection process based on the SVs or other values assigned to the nodes.

A pseudo code that may be used for the first stage of the parent snapshot delete operation in accordance with an embodiment of the invention is as follows:

```
// 1st stage
traverseNode(node, rpRoot) {
  add(node, exclusiveNodeList)
  for child in node−>children:
    /* Enter into child node for traversal if the child node is not found in the
    running point logical map by using the minimum key of the child node. */
  if !lookup(child−>minKey, rpRoot, child):
      traverseNode(child, rpRoot)
}
```

In the above pseudo code, the minimum key of the child node is used to determine whether the page of the node in an extent of the storage is accessible by the child snapshot, i.e., the running point, where the extent is one or more contiguous blocks of a physical storage and the page is the data of the node stored in the extent. For a leaf node of a COW B+ tree, each extent has a unique key (i.e., a minimum key), which can be used to locate the extent if it is also accessible by the logical map of the child snapshot (e.g., the running point). For an index node, the extent consisted of a pair of data: a pivot key and a pointer to a child node. The keys of extents under the child node are equal to or larger than the pivot key. So, the look-up process for an extent with the key same as the value of a pivot key can traverse the index node if the index node is accessible by the child snapshot as well. Although the minimum key is used in an embodiment, another key in the page of a child node can be used.

For the above pseudo code, a node with an SV less than the minSV of the parent snapshot of the running point, i.e., shared with the grandparent snapshot of the running point, is filtered out before the step of adding the node to the exclusive node list of the parent snapshot, i.e., the line—add(node, exclusiveNodeList).

Turning back to FIG. 5, at block 504, the second stage of the parent snapshot delete operation is executed by the snapshot manager 400. During this stage, processed shared nodes that are accessible to the parent snapshot can be copied out for writes at the running point during a period of time when the first stage is still being executed and before the third stage is initiated. After a shared node has been copied out during this stage, the source node (the original shared node) will not be accessed by the running point anymore. This kind of node will be added to the exclusive node list of the parent snapshot as well, in addition to the exclusively owned nodes found during the execution of the first stage.

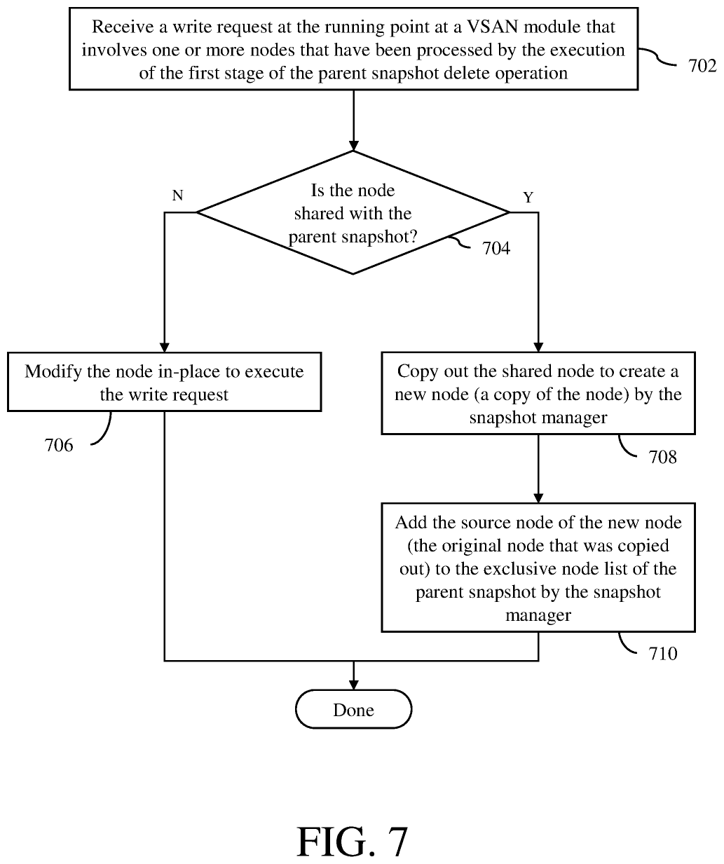

Turning now to FIG. 7, a flow diagram of a process to execute the second stage of the parent snapshot delete operation in accordance with an embodiment of the invention is shown. At step 702, a write request at the running point is received at a VSAN module 114 that involves one or more nodes that have been processed by the execution of the first stage of the parent snapshot delete operation. Next, at step 704, for each node involved in the write request, a determination is made by the VSAN module whether the node is shared with the parent snapshot. In an embodiment, a node involved in a write request for the running point is determined to be shared with the parent snapshot if the SV of the node is less than the minSV of the running point.

If the node is not shared with the parent snapshot, then the process proceeds to block 706, where the node is modified in-place to execute the write request by the VSAN module 114. The process then comes to an end. However, if the node is shared with the parent snapshot, then the process proceeds to block 708, where the shared node is copied out to create a new node, which is a copy of the shared node, by the VSAN module. Thus, the shared node is the source node of the new node. This new node is then modified to fulfill the write request. Next, at step 710, the source node of the new node, i.e., the shared node that was copied out, is added to the exclusive node list of the parent snapshot by the snapshot manager 400. The process is now completed. This process is repeated for every write request that involves one or more nodes that have been processed by the execution of the first stage of the parent snapshot delete operation, until the third stage is executed.

A pseudo code that may be used for the second stage of the parent snapshot delete operation in accordance with an embodiment of the invention is as follows:

```
// 2nd stage
copyNodeOnWrite(node) {
  /* Copy out new node from a node shared with parent snapshot and add the
  source node into the exclusiveNodeList of the parent snapshot. */
    if node−>SN < rp−>minSN:
      newNode = copy(node)
      add(node, exclusiveNodeList)
}
```

Turning back to FIG. 5, at block 506, the third stage of the parent snapshot delete operation is executed by the snapshot manager 400. During this stage, the minSV of the running point is updated by the snapshot manager to the value of the minSV of the parent snapshot, in order to transfer the ownership of all remaining nodes shared between the parent snapshot and the running point that are not included in the exclusive node list to the running point. After this update of the minSV of the running point, all shared nodes owned by the parent snapshot will be owned by the running point. Thus, new writes at these nodes will not trigger node copy-out. That is, new writes at these nodes are executed by modifying or updating the nodes in-place, rather than using copies of the nodes to execute the writes.

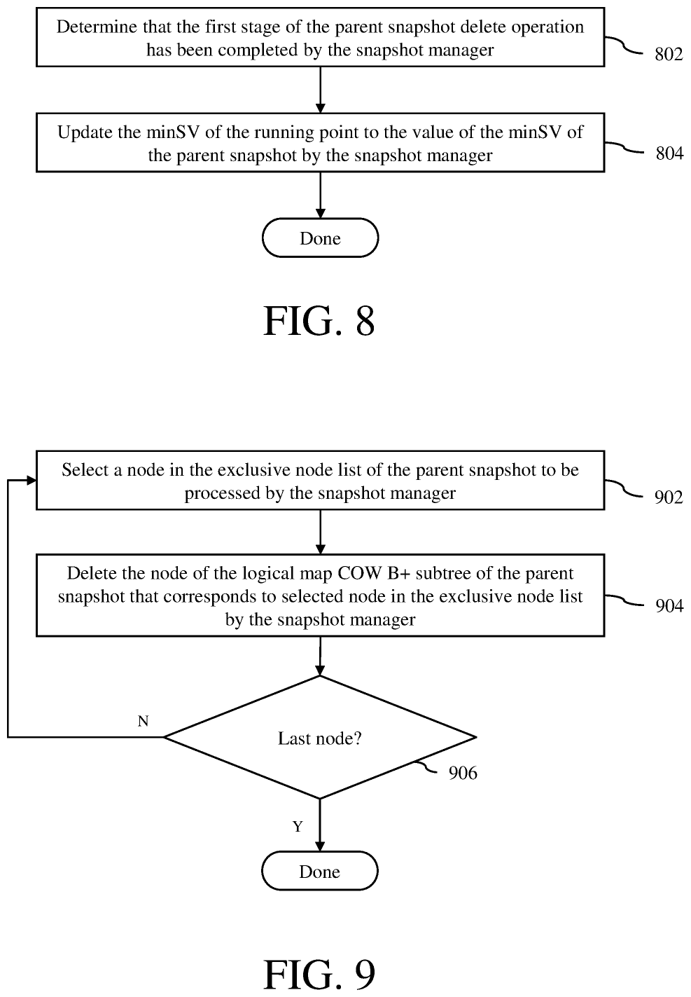

Turning now to FIG. 8, a flow diagram of a process to execute the third stage of the parent snapshot delete operation in accordance with an embodiment of the invention is shown. At step 802, a determination is made by the snapshot manager 400 that the first stage of the parent snapshot delete operation has been completed, i.e., the COW B+ subtree corresponding to the logical map of the parent snapshot of the storage object running point has been traversed to select shared nodes to be included in the exclusive node list. Thus, all the nodes of the COW B+ subtree corresponding to the logical map of the parent snapshot of the storage object running point have been visited and processed, as described above with respect to the first stage of the parent snapshot delete operation.

Next, at step 804, the minSV of the running point is updated to the value of the minSV of the parent snapshot by the snapshot manager 400. As a result, the ownership of all remaining nodes shared between the parent snapshot and the running point are transferred to the running point. Thus, any new writes that involve these remaining shared nodes will not require copies of the remaining shared nodes. Instead, the new writes can be executed using the original remaining shared nodes.

Turning back to FIG. 5, at block 508, the fourth stage of the parent snapshot delete operation is executed by the snapshot manager 400. During this stage, the nodes of the COW B+ subtree corresponding to the logical map of the parent snapshot of the storage object running point that are listed in the exclusive node list of the parent snapshot are deleted, which in effect deletes the logical map of the parent snapshot.

Turning now to FIG. 9, a flow diagram of a process to execute the fourth stage of the parent snapshot delete operation in accordance with an embodiment of the invention is shown. At step 902, a node in the exclusive node list of the parent snapshot is selected to be processed by the snapshot manager 400. Next, at step 904, the node of the logical map COW B+ subtree of the parent snapshot that corresponds to selected node in the exclusive node list is deleted, e.g., free the storage space occupied by the logical map COW B+ subtree node, by the snapshot manager. Next, at step 906, a determination is made by the snapshot manager whether the current node is the last node in the exclusive node list of the parent snapshot. If the current node is the last node to be processed, then the process is completed. However, if the current node is not the last node in the exclusive node list of the parent snapshot, the proceeds back to step 902, where the next node in the exclusive node list of the parent snapshot is selected to be processed.

A pseudo code that may be used for the fourth stage of the parent snapshot delete operation in accordance with an embodiment of the invention is as follows:

```
// 4th stage
deleteSnapshotLogicalMap( )
  for node in nodeExclusiveList:
    deleteNode(node)
}
```

In an alternative embodiment, the logical tree of the parent snapshot may be traversed to find nodes that are in the exclusive node list of the parent snapshot. If a node in the logical tree of the parent snapshot is found in the exclusive node list of the parent snapshot, then that node is deleted. This process is continued until all the nodes of the logical tree of the parent snapshot have been processed.

A pseudo code that may be used for the fourth stage of the parent snapshot delete operation in accordance with the alternative embodiment of the invention is as follows:

```
// 4th stage
deleteNode(node) {
  for child in node−>children:
    /* Skip the child node that is not in the exclusiveNodeList. */
    if find(child, exclusiveNodeList):
      deleteNode(child)
  release(node)
}
```

Turning back to FIG. 5, after the fourth stage of the parent snapshot delete operation has been completed at block 508, all the nodes of the COW B+ subtree that are exclusively owned by the parent snapshot have been deleted, which effectively removes the logical map of the parent snapshot from the COW B+ tree of the storage object.

In an embodiment, metadata of snapshots for the storage object is maintained by the snapshot manager 400 in persistent storage. The metadata of snapshots for the storage object may be stored in a B+ tree (“snapTree”) to keep the records of all active snapshots, which include the running point. The snapshot metadata may include at least an identifier and the logical map root node for each snapshot. When the parent snapshot is being deleted, the snapshot metadata may be updated to remove the parent snapshot metadata information from the snapshot metadata.

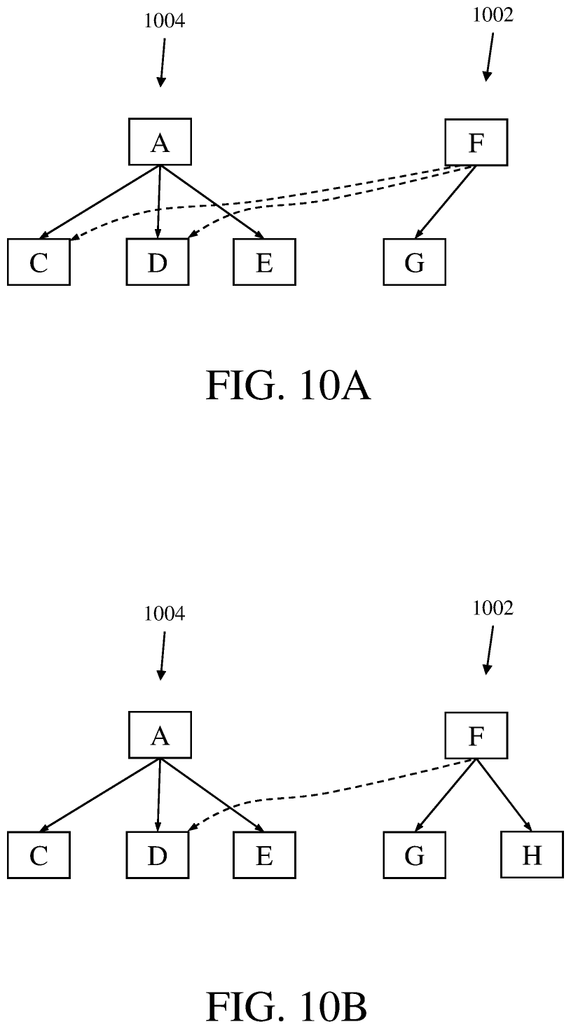

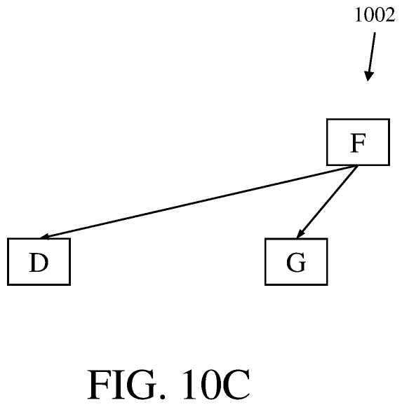

The parent snapshot delete operation is further described using an example of a COW B+ tree structure shown in FIG. 10A, which includes a COW B+ subtree 1002 for the running point (RP) and a COW B+ subtree 1004 for the parent snapshot of the running point. As shown in FIG. 10, the COW B+ subtree 1004 of the parent snapshot includes nodes A, C, D and E, where the node A is the root node of the parent snapshot and the nodes C, D and E are the child nodes of the root node A. The COW B+ subtree 1002 of the running point includes nodes F, and G, as well as the nodes C and D, where the node F is the root node of the running point and the nodes C, D and G are the child nodes of the root node F. Thus, the nodes C and D are shared between the parent snapshot and the running point. The sequence values (SVs) of the nodes A, C, D, E, F and G are as follows: A=SV1, C=SV2, D=SV3, E=SV4, F=SN5 and G=SV6, where SV1<SV2<SV3<SV4<SV5<SV6. Thus, the node layout of the parent snapshot can be expressed as: [A=SV1, C=SV2, D=SV3, E=SV4] and the node layout of the running point can be expressed as: [F=SV5, C, D, G=SN6]. In this example, the minSV of the parent snapshot is SV1 and the minSV of the running point is SV5.

Initially, the exclusive node list of the parent snapshot is empty, i.e., exclusiveNodeList=[ ]. During the first stage of the parent snapshot delete operation, the nodes A and E will be put into the exclusive node list of the parent snapshot, since these nodes are not shared with running point, i.e., exclusiveNodeList=[A, E]. At the second stage of the parent snapshot delete operation before the first stage is finished, the node C is copied out as new node H for a new write IO at the running point that involves the node C because the SV of the node C is SV2 and SV2<SV5, and thus, the SV of the node C is less than the minSV (SV5) of the running point. That is, the node C is shared between the parent snapshot and the running point. The SV of the new node H is SV7. After the node C is copied out, the node C is put into the exclusive node list, i.e., exclusiveNodeList=[A, C, E] because the node C is now exclusively owned by the parent snapshot. Thus, the node layout of the parent snapshot can now be expressed as: [A=SV1, C=SV2, D=SV3, E=SV4] and the node layout of the running point can be expressed as: [F=SV5, H=SV7, D, G=SN6], which is illustrated in FIG. 10B.

At the third stage of the parent snapshot delete operation, the minSV of the running point is changed to SV1, which is the minSV of the parent snapshot. After the minSV of the running point has been changed to SV1, any new write IOs that involve any of the nodes having an SV equal to or greater than the new minSV of the running point (i.e., SV1) will be in-place operated at those nodes. For example, if the node D is involved in a new write IO at the running point, then the update for the new write IO will be in-place updated at the node D.

At the fourth stage of the parent snapshot delete operation, the nodes in the exclusive node list, i.e., the nodes A, C and E, will be deleted. After the fourth stage is completed, the node layout of the running point can be expressed as: [F=SV5, H=SV7, D=SN3, G=SN6], which is illustrated in FIG. 10C. Since all the exclusively owned nodes of the parent snapshot have been deleted from the COW B+ subtree 1004, there will be no node layout of the parent snapshot, i.e., the logical map of the parent snapshot has been deleted, as illustrated in FIG. 10C.

In an embodiment, the process of deleting a node of the logical map COW B+ subtree of the parent snapshot found in the exclusive node list of the parent snapshot involves updating a block allocation bitmap of the nodes of the COW B+ tree that includes the parent snapshot being deleted. In this embodiment, when a node of an COW B+ tree is allocated to a block, i.e., the node is to be stored in the block, a corresponding bit in the block allocation bitmap is marked as used. When a node of the COW B+ tree is being deallocated or deleted, a corresponding bit in the block allocation bitmap is marked as free. Thus, the nodes of the logical map COW B+ subtree of the parent snapshot found in the exclusive node list of the parent snapshot can be deleted by updating the bits in the block allocation bitmap corresponding to the blocks used for the nodes being deleted.

The process of updating a block allocation bitmap of nodes of a COW B+ tree in accordance with an embodiment is described using a simple example. In this example, a disk of 48 KB (kilobytes) and 4 KB blocks are used. Thus, the disk has 12 blocks.

Initially, all the blocks are free as indicated below.

| | | | | | | | | | | | | |
|---|---|---|---|---|---|---|---|---|---|---|---|---|
| block index | B0 | B1 | B2 | B3 | B4 | B5 | B6 | B7 | B8 | B9 | B10 | B11 |

block alloc bitmap

After allocation of nodes A (B0), C (B1), D (B2) and E (B3), the block allocation bitmap is updated as follows:

| | | | | | | | | | | | | |
|---|---|---|---|---|---|---|---|---|---|---|---|---|
| block index | B0 | B1 | B2 | B3 | B4 | B5 | B6 | B7 | B8 | B9 | B10 | B11 |

| | | | | |
|---|---|---|---|---|
| block alloc bitmap | X | X | X | X |

After allocation of nodes F (B4) and G (B5), the block allocation bitmap is further updated as follows:

| | | | | | | | | | | | | |
|---|---|---|---|---|---|---|---|---|---|---|---|---|
| block index | B0 | B1 | B2 | B3 | B4 | B5 | B6 | B7 | B8 | B9 | B10 | B11 |

| | | | | | | |
|---|---|---|---|---|---|---|
| block alloc bitmap | X | X | X | X | X | X |

After allocation of node H (B6), the block allocation bitmap is further updated as follows:

| | | | | | | | | | | | | |
|---|---|---|---|---|---|---|---|---|---|---|---|---|
| block index | B0 | B1 | B2 | B3 | B4 | B5 | B6 | B7 | B8 | B9 | B10 | B11 |

| | | | | | | |
|---|---|---|---|---|---|---|
| block alloc bitmap | X | X | X | X | X | X |

Thus, when nodes are allocated at certain blocks, the bits of the block allocation bitmap corresponding to those blocks are updated to indicate that those blocks are used.

After deallocation or deletion of node C (B1), the block allocation bitmap is updated as follows:

| | | | | | | | | | | | | |
|---|---|---|---|---|---|---|---|---|---|---|---|---|
| block index | B0 | B1 | B2 | B3 | B4 | B5 | B6 | B7 | B8 | B9 | B10 | B11 |

| | | | |
|---|---|---|---|
| block alloc bitmap | X | X | X |

After deallocation or deletion of E (B3) and A (B0), the block allocation bitmap is further updated as follows:

| | | | | | | | | | | | | |
|---|---|---|---|---|---|---|---|---|---|---|---|---|
| block index | B0 | B1 | B2 | B3 | B4 | B5 | B6 | B7 | B8 | B9 | B10 | B11 |

| | | | |
|---|---|---|---|
| block alloc bitmap | X | X | X |

Thus, when nodes are deleted or deallocated at certain blocks, the bits of the block allocation bitmap corresponding to those blocks are updated to indicate that those blocks are free.

The block allocation bitmap may be stored in one or more of the blocks of the disk along with the nodes. Alternatively, the block allocation bitmap may be stored elsewhere in any physical storage.

In the embodiment where the metadata of snapshots for the storage object is maintained by the snapshot manager 400, the snapshot metadata may be updated to remove the parent snapshot metadata information from the snapshot metadata after all the nodes in the exclusive node list of the parent snapshot have been deleted. In the above example, before deleting the parent snapshot, the snapshot metadata maintained in the snapTree is as follows:
snapTree layout: [snapId=1, logicalMapRootNode=A], [snapId=2, logicalMapRootNode=F].
   After deleting the parent snapshot, the snapshot metadata is as follows:
snapTree layout: [snapId=2, logicalMapRootNode=F].

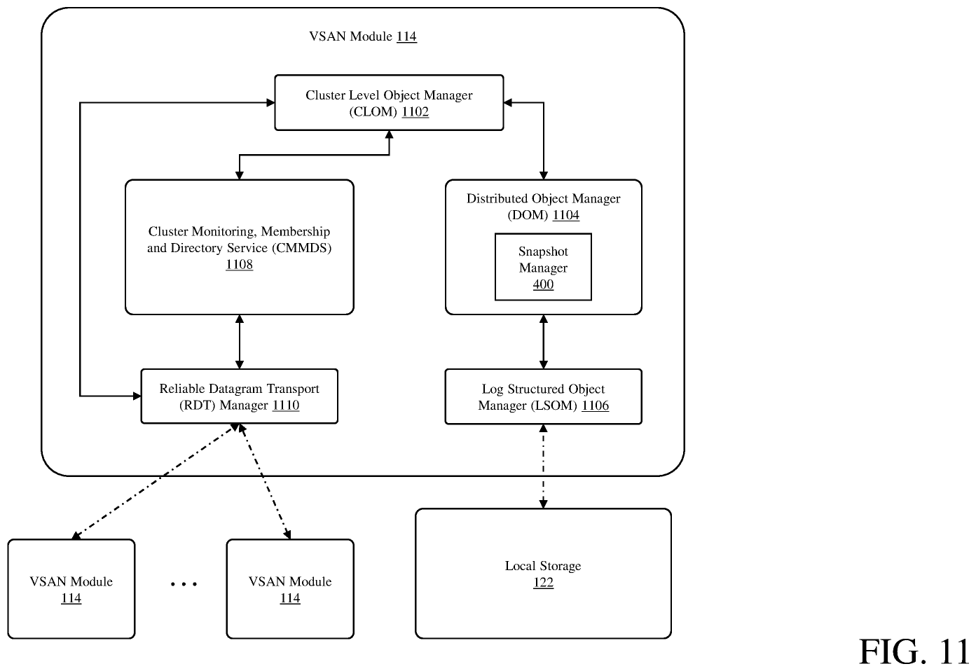

Turning now to FIG. 11, components of the VSAN module 114, which is included in each host computer 104 in the cluster 106, in accordance with an embodiment of the invention are shown. As illustrated in FIG. 11, the VSAN module includes a cluster level object manager (CLOM) 1102, a distributed object manager (DOM) 1104, a local log structured object management (LSOM) 1106, a cluster monitoring, membership and directory service (CMMDS) 1108, and a reliable datagram transport (RDT) manager 1110. These components of the VSAN module may be implemented as software running on each of the host computers in the cluster.

The CLOM 1102 operates to validate storage resource availability, and the DOM 1104 operates to create components and apply configuration locally through the LSOM 1106. The DOM 1104 also operates to coordinate with counterparts for component creation on other host computers 104 in the cluster 106. All subsequent reads and writes to storage objects funnel through the DOM 1104, which will take them to the appropriate components. The LSOM 1106 operates to monitor the flow of storage I/O operations to the local storage 122, for example, to report whether a storage resource is congested. The CMMDS 1108 is responsible for monitoring the VSAN cluster's membership, checking heartbeats between the host computers in the cluster, and publishing updates to the cluster directory. Other software components use the cluster directory to learn of changes in cluster topology and object configuration. For example, the DOM uses the contents of the cluster directory to determine the host computers in the cluster storing the components of a storage object and the paths by which those host computers are reachable.

The RDT manager 1110 is the communication mechanism for storage-related data or messages in a VSAN network, and thus, can communicate with the VSAN modules 114 in other host computers 104 in the cluster 106. As used herein, storage-related data or messages (simply referred to herein as “messages”) may be any pieces of information, which may be in the form of data streams, that are transmitted between the host computers 104 in the cluster 106 to support the operation of the VSAN 102. Thus, storage-related messages may include data being written into the VSAN 102 or data being read from the VSAN 102. In an embodiment, the RDT manager uses the Transmission Control Protocol (TCP) at the transport layer and it is responsible for creating and destroying on demand TCP connections (sockets) to the RDT managers of the VSAN modules in other host computers in the cluster. In other embodiments, the RDT manager may use remote direct memory access (RDMA) connections to communicate with the other RDT managers.

As illustrated in FIG. 11, the snapshot manager 400 for the VSAN module 114 is located in the DOM 1104 to perform the operations described above with respect to the flow diagrams of FIGS. 5-9. However, in other embodiments, the snapshot manager may be located elsewhere in each of the host computers 104 in the cluster 106 to perform the operations described herein.

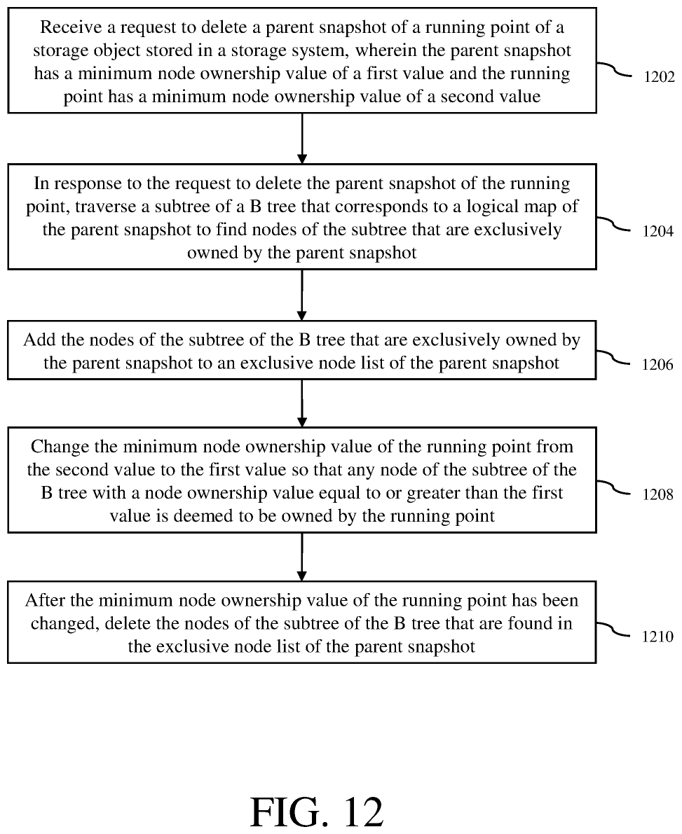

A computer-implemented method for deleting parent snapshots of running points of storage objects stored in a storage system in accordance with an embodiment of the invention is described with reference to a flow diagram of FIG. 12. At block 1202, a request to delete a parent snapshot of a running point of a storage object stored in the storage system is received. The parent snapshot has a minimum node ownership value of a first value and the running point has a minimum node ownership value of a second value. At block 1204, in response to the request to delete the parent snapshot of the running point, a subtree of a B tree that corresponds to a logical map of the parent snapshot is traversed to find nodes of the subtree that are exclusively owned by the parent snapshot. At block 1206, the nodes of the subtree of the B tree that are exclusively owned by the parent snapshot are added to an exclusive node list of the parent snapshot. At block 1208, the minimum node ownership value of the running point is changed from the second value to the first value so that any node of the subtree of the B tree with a node ownership value equal to or greater than the first value is deemed to be owned by the running point. At block 1210, after the minimum node ownership value of the running point has been changed, the nodes of the subtree of the B tree that are found in the exclusive node list of the parent snapshot are deleted.

The components of the embodiments as generally described in this document and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disc, and an optical disc. Current examples of optical discs include a compact disc with read only memory (CD-ROM), a compact disc with read/write (CD-R/W), a digital video disc (DVD), and a Blu-ray disc.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer-implemented method for deleting parent snapshots of running points of storage objects stored in a storage system, the method comprising:
receiving a request to delete a parent snapshot of a running point of a storage object stored in the storage system, wherein the parent snapshot has a minimum node ownership value of a first value and the running point has a minimum node ownership value of a second value;
in response to the request to delete the parent snapshot of the running point, traversing a subtree of a B tree that corresponds to a logical map of the parent snapshot to find nodes of the subtree that are exclusively owned by the parent snapshot;
adding the nodes of the subtree of the B tree that are exclusively owned by the parent snapshot to an exclusive node list of the parent snapshot;
changing the minimum node ownership value of the running point from the second value to the first value so that any node of the subtree of the B tree with a node ownership value equal to or greater than the first value is deemed to be owned by the running point; and
after the minimum node ownership value of the running point has been changed, deleting the nodes of the subtree of the B tree that are found in the exclusive node list of the parent snapshot.

2. The method of claim 1, wherein the node ownership value for each of the nodes of the subtree of the B tree is a monotonically increased value.

3. The method of claim 1, wherein traversing the subtree of the B tree includes determining whether a particular node of the subtree of the B tree is accessible to the running point and whether the particular node is accessible to a grandparent snapshot of the running point to determine whether the particular node is exclusively owned by the parent snapshot.

4. The method of claim 1, further comprising:
after a particular node of the subtree of the B tree that is accessible to both the parent snapshot and the running point is processed by the traversing of the subtree of the B tree and before changing the minimum node ownership value of the running point, copying out the particular node of the subtree of the B tree to produce a new node accessible to the running point when a write request involving the particular node is executed; and
after the new node is produced, adding the particular node to the exclusive node list.

5. The method of claim 1, further comprising, after changing the minimum node ownership value of the running point, updating a particular node of the subtree of the B tree that was determined to be not exclusive owned by the parent snapshot without copying out the particular node when a write request involving the particular node is executed.

6. The method of claim 1, wherein traversing the subtree of the B tree includes determining whether a particular node of the subtree of the B tree is not shared between the parent snapshot and a grandparent snapshot of the running point by comparing a node ownership value of the particular node and the minimum node ownership value of the parent snapshot.

7. The method of claim 1, wherein traversing the subtree of the B tree includes determining whether a particular node of the subtree of the B tree is not shared between the parent snapshot and the running point by looking up a key for locating an extent that is included in the particular node, the particular node being not shared between the parent snapshot and the running point when the key is not found in a logical map of the running point.

8. The method of claim 1, wherein deleting the nodes of the subtree of the B tree includes indicating deallocation of blocks corresponding to the nodes in a block allocation bitmap.

9. The method of claim 1, wherein the B tree is a copy-on-write B+ tree.

10. A non-transitory computer-readable storage medium containing program instructions for deleting parent snapshots of running points of storage objects stored in a storage system, wherein execution of the program instructions by one or more processors of a computer system causes the one or more processors to perform steps comprising:
receiving a request to delete a parent snapshot of a running point of a storage object stored in the storage system, wherein the parent snapshot has a minimum node ownership value of a first value and the running point has a minimum node ownership value of a second value;
in response to the request to delete the parent snapshot of the running point, traversing a subtree of a B tree that corresponds to a logical map of the parent snapshot to find nodes of the subtree that are exclusively owned by the parent snapshot;
adding the nodes of the subtree of the B tree that are exclusively owned by the parent snapshot to an exclusive node list of the parent snapshot;
changing the minimum node ownership value of the running point from the second value to the first value so that any node of the subtree of the B tree with a node ownership value equal to or greater than the first value is deemed to be owned by the running point; and
after the minimum node ownership value of the running point has been changed, deleting the nodes of the subtree of the B tree that are found in the exclusive node list of the parent snapshot.

11. The non-transitory computer-readable storage medium of claim 10, wherein the node ownership value for each of the nodes of the subtree of the B tree is a monotonically increased value.

12. The non-transitory computer-readable storage medium of claim 10, wherein traversing the subtree of the B tree includes determining whether a particular node of the subtree of the B tree is accessible to the running point and whether the particular node is accessible to a grandparent snapshot of the running point to determine whether the particular node is exclusively owned by the parent snapshot.

13. The non-transitory computer-readable storage medium of claim 10, wherein the steps further comprise:
after a particular node of the subtree of the B tree that is accessible to both the parent snapshot and the running point is processed by the traversing of the subtree of the B tree and before changing the minimum node ownership value of the running point, copying out the particular node of the subtree of the B tree to produce a new node accessible to the running point when a write request involving the particular node is executed; and
after the new node is produced, adding the particular node to the exclusive node list.

14. The non-transitory computer-readable storage medium of claim 10, wherein the steps further comprise, after changing the minimum node ownership value of the running point, updating a particular node of the subtree of the B tree that was determined to be not exclusive owned by the parent snapshot without copying out the particular node when a write request involving the particular node is executed.

15. The non-transitory computer-readable storage medium of claim 10, wherein traversing the subtree of the B tree includes determining whether a particular node of the subtree of the B tree is not shared between the parent snapshot and a grandparent snapshot of the running point by comparing a node ownership value of the particular node and the minimum node ownership value of the parent snapshot.

16. The non-transitory computer-readable storage medium of claim 10, wherein traversing the subtree of the B tree includes determining whether a particular node of the subtree of the B tree is not shared between the parent snapshot and the running point by looking up a key for locating an extent that is included in the particular node, the particular node being not shared between the parent snapshot and the running point when the key is not found in a logical map of the running point.

17. The non-transitory computer-readable storage medium of claim 10, wherein deleting the nodes of the subtree of the B tree includes indicating deallocation of blocks corresponding to the nodes in a block allocation bitmap.

18. A computer system comprising:
a storage system having computer data storage devices;
memory; and
at least one processor configured to:
receive a request to delete a parent snapshot of a running point of a storage object stored in the storage system, wherein the parent snapshot has a minimum node ownership value of a first value and the running point has a minimum node ownership value of a second value;
in response to the request to delete the parent snapshot of the running point, traverse a subtree of a B tree that corresponds to a logical map of the parent snapshot to find nodes of the subtree that are exclusively owned by the parent snapshot;
add the nodes of the subtree of the B tree that are exclusively owned by the parent snapshot to an exclusive node list of the parent snapshot;
change the minimum node ownership value of the running point from the second value to the first value so that any node of the subtree of the B tree with a node ownership value equal to or greater than the first value is deemed to be owned by the running point; and
after the minimum node ownership value of the running point has been changed, delete the nodes of the subtree of the B tree that are found in the exclusive node list of the parent snapshot.

19. The computer system of claim 18, wherein the at least one processor is configured to determine whether a particular node of the subtree of the B tree is accessible to the running point and whether the particular node is accessible to a grandparent snapshot of the running point to determine whether the particular node is exclusively owned by the parent snapshot.

20. The computer system of claim 18, wherein the at least one processor is configured to:
after a particular node of the subtree of the B tree that is accessible to both the parent snapshot and the running point is processed by a transversal of the subtree of the B tree and before the minimum node ownership value of the running point is changed, copy out the particular node of the subtree of the B tree to produce a new node accessible to the running point when a write request involving the particular node is executed; and
after the new node is produced, add the particular node to the exclusive node list.
